(19) United States
(12) Patent Application Publication
(10) Pub. No.: US 2019/0244170 A1
(43) Pub. Date: Aug. 8, 2019

(54) METHODS AND SYSTEMS FOR ASSIGNING A CLASSIFICATION CODE TO ITEMS IN COMMERCE

(71) Applicant: Flexport, Inc., San Francisco, CA (US)

(72) Inventor: Chase Brownell, San Francisco, CA (US)

(21) Appl. No.: 16/271,565

(22) Filed: Feb. 8, 2019

Related U.S. Application Data
(60) Provisional application No. 62/627,919, filed on Feb. 8, 2018.

(51) Int. Cl. G06Q 10/08

(52) U.S. Cl. CPC G06Q 10/0833; G06Q 10/0838

(57) ABSTRACT

In an embodiment, the methods and systems disclosed herein utilize a classification engine to receive characteristic data of an item involved in commercial shipping and generate a classification code to aid in transport of the item. In an embodiment, a profile comprising classification data is generated on the classification engine and compared to a plurality of shipping categories on a classification database to efficiently generate the classification code.

### BENEFIT CLAIM

This application claims the benefit under 35 U.S.C. § 119(e) of provisional application 62/627,919 filed Feb. 8, 2018, the entire contents of which is hereby incorporated by reference for all purposes as if fully set forth herein.

### TECHNICAL FIELD

One technical field of the present disclosure is freight shipping and management. Another technical field is computer systems for classification and categorization of object characteristics.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Items in commerce are any items, objects, products, work-product, or tools which are transported from one location to another as part of a commercial transaction or contract. The modern freight shipping industry involves transporting copious amounts of items and products to and from various locations around the world and often across numerous borders. As a result, modern shipping processes must track and manage large amounts of logistical information in order to efficiently and accurately transport objects from one location to another. A single mistake during the shipping process, such a mislabeling or mis-categorizing an item, can cause the delay of an entire shipment by days, weeks, or even longer. Expanding shipping activity and globalization of commerce requires that commerce processing systems constantly evolve to promote efficient management and decision-making. Mistakes are possible at each step which may slow the pace of shipping or halt the process altogether. Despite the importance of minimizing errors, the freight shipping industry has not adopted more convenient and beneficial technology to achieve these goals.

A previous attempt to streamline commercial shipping is the International Harmonized System (HS) which serves as the foundation as the import and export classification systems in the United States. The Harmonized Tariff Schedule (HTS) provides the international HS codes based on 4- and 6-digit headings and subheadings, and in some instances, greater commodity details are needed than the 4- and 6-digit HS headings and subheadings to properly ship items. Preventing errors with the HS code system is important because any error in an item's designated classification code can result in a different tariff for transporting the item, affecting the cost to shippers and transporters alike, and potentially delaying the shipment.

Conversely, investing significant time in determining a proper classification code consumes valuable time and resources which could be utilized in shipping operations. Due to the complexity of the HTS, most companies rely upon product experts to properly classify their products. Even with expert assistance, the HTS is still subject to errors in interpretation. As a result, even an expert classifier may misclassify a product. A person trying to classify a stone statue might have to rely on previous experience, consult explanatory notes, compare various chapters, etc., to determine the right classification, all while wasting valuable time and potentially delaying shipping operations.

Therefore, there exists a need in the fields of commercial shipping and freight transportation for quick and efficient methods of classifying objects with a proper classification code without having to rely on manually generated and time-consuming determinations of classification codes.

### SUMMARY

The appended claims may serve as a summary of the invention.

### BRIEF DESCRIPTION OF THE DRAWINGS

In the drawings:

FIG. 1 depicts a system that may be used to implement an embodiment.

FIG. 2 depicts an example process that may govern the operation of an embodiment.

FIG. 3 depicts an example general purpose computer system that may be used to implement aspects of an embodiment.

FIG. 4 depicts an example embodiment that may be used in implementing the example process.

FIG. 5 depicts an example embodiment that may be used in implementing the example process.

FIG. 6A depicts an example embodiment that may be used in implementing the example process.

FIG. 6B depicts an example embodiment that may be used in implementing the example process.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In various embodiments of the techniques herein, a computer implemented method assigns a classification code to items in commerce to improve classification of goods involved in interstate or international commerce. A classification engine receives multiple characteristics of the item, which must be associated with proper a classification code for efficient shipping and processing to progress. The classification engine interacts with multiple computer entities, such as a user device and a category database to accomplish more efficient and precise classification code generation for the item.

Generating a proper classification code begins with the reception, at the classification engine, of a plurality of properties associated with the item, such as weight, dimensions, properties or matter, shipping destination, etc. These properties can be taken from user input created at a user device, and directly describe the item according to a user's own senses. Additional properties can be taken from any number of historical databases, computer memories, or shipping rules and guidelines. The classification engine creates a virtual profile of the item based on the received properties reflecting a close approximation of the item's real properties.

The profile of the item is compared against a plurality of shipping categories stored on a classification database. The shipping categories define the metes and bounds of how an item is classified at shipping, such as restrictions placed on the transport of liquids, heavy objects, flammable materials, etc. By determining the categories most closely approximating the characteristics of the item, the generated profile of the item can assist in tailoring a unique classification code to the item. By quickly and precisely generating a proper classification code for an object, the classification engine will save buyers, sellers, shippers, and various other entities involved in commercial activities time and resources otherwise spent manually determining a proper classification for an object.

Generation of an accurate classification code for association with an item in commerce saves significant time and computing resources over traditional methods of manually assigning classification codes. Manual classification procedures performed by human experts are subject to human error and time inconsistencies, and require time and computing resources to look-up classification protocols, look-up international code standards, double-check the accuracy of classification codes, and inquire to third-parties on the nature of certain items. The method described herein saves precious computer processing resources, computer memory, network bandwidth, and time, by quickly, efficiently, and accurately generating classification codes. The field of commercial transportation, which constantly grows exponentially more complex, is greatly improved by such a method for keeping modern transactions efficient and viable.

System Implementation

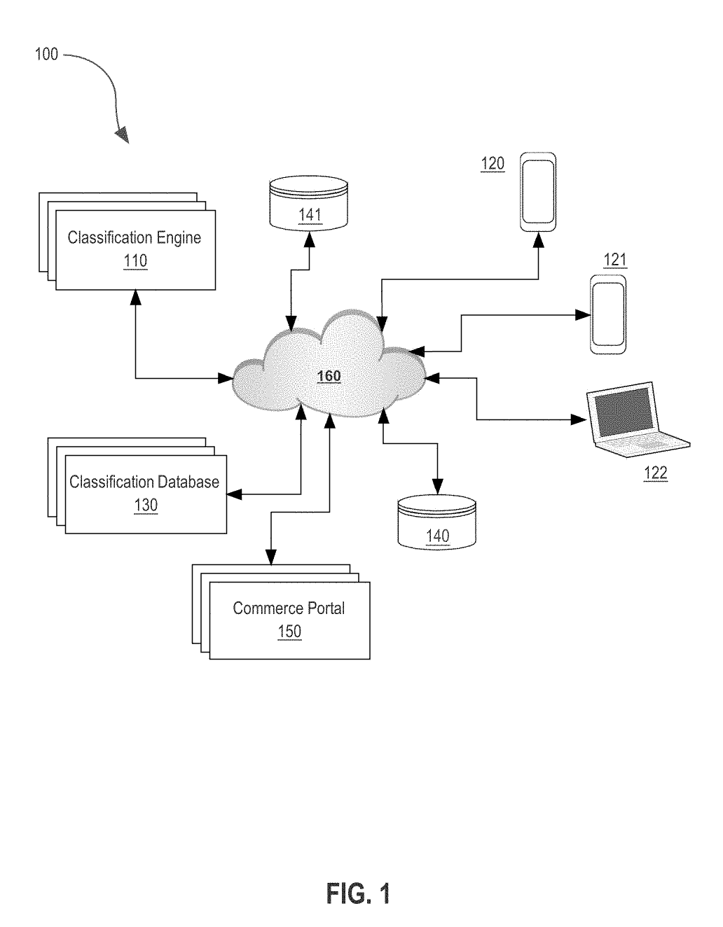

FIG. 1 depicts an example system 100 for the assignment of classification codes to an item which is the subject of commercial shipping. Network 160 connects devices and systems 110-150. Network 160 may be any appropriate local area network, internet, and/or other type of network or communication mechanism, including those discussed herein. Coupled to network 160 is classification engine 110. Classification engine 110 may be any device, system, or entity which is capable of receiving information related to an item which is the subject of commercial shipping.

Classification engine 110 is connected to commerce portal 150 through network 160. Commerce portal 150 may be a front-end software executing on a device such as user devices 120-122. A user may input information at one of user devices 120-122 which is sent to commerce portal 150, which will send the information to classification engine 110.

Classification engine 110 is connected to classification database 130 by network 160. Classification database 130 may be any device, system, or entity capable of storing a plurality of categories relating to characteristics of an item which is the subject of commercial shipping. Classification database may store a plurality of categories which, when grouped in a particular manner, indicate a unique classification code which describes an item which is the subject of commercial shipping, according to an established shipping standard.

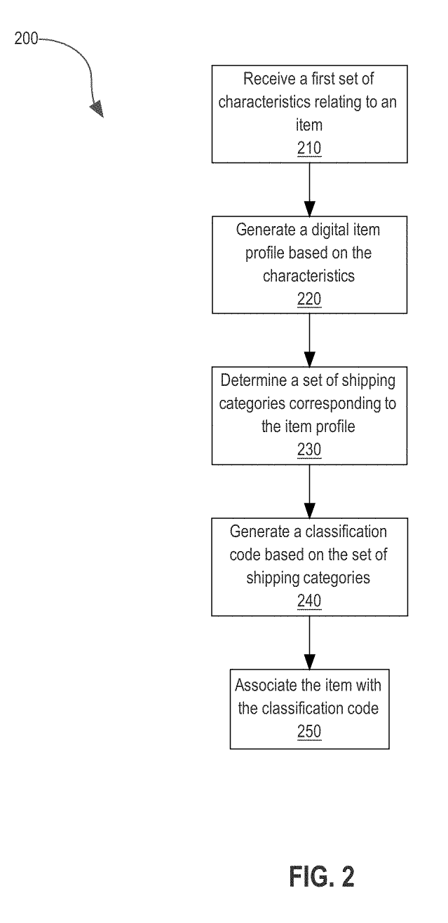

Coupled to network 160 are one or more storage devices 140-141 which may be used in lieu of any device, system or entity capable of storing digital information as otherwise discussed herein. In various embodiments, the example system 100 as described herein executes the steps of process 200 in FIG. 2.

Process Overview

FIG. 2 depicts an example process 200 that may govern operation of an embodiment. Process 200 begins with receiving 210 a first set of characteristics describing an item which will be the subject of commercial shipping. A digital profile is generated 220 for the item comprising the items characteristics. A set of shipping categories is determined 230 which correspond to the characteristics described in the digital profile. Based on the set of shipping categories, a classification code is generated 240 and associated 250 with the item.

Returning to step 210, a first set of digitally generated characteristic data is received. In various embodiments, a user inputs characteristic data manually into one of user devices 120-122. The characteristic data describes a physical item having physical characteristics and which will be the subject of a commercial shipping action. The characteristic data may be processed by commerce portal 150 running on one of the user devices 120-122 and sent to classification engine 110 for commencement of process 200. For example, a user in possession of a wooden crate, which the user desires to transport commercially, may input, at mobile device 120, physical characteristics of the wooden crate, such as “crate,” “wooden” and “cubic.” The commerce portal 150 may recognize these terms as known terms parsable by the classification engine 110 and send the terms as digital data to classification engine 110.

At step 220, a digital item profile is generated based on the received characteristic data. In various embodiments, the classification engine 110 groups terms and data received from the commerce portal 150 to create a digital item profile which represents the amalgamated characteristics of the described item. For example, the classification engine may use the received term “crate” to create a digital item profile indicating a crate, and further populate the profile with sub-characteristics such as “wooden” and “cubic” to match the physical properties of the crate as closely as possible.

At step 230, based on the generated digital item profile, a set of corresponding shipping categories is determined which match the stored characteristics in the digital item profile. Shipping categories may be any data or data structure, at least a portion of which, is data comprising a digital description of a physical property. Classification database 130 may store a plurality of shipping categories. A set of shipping categories of the plurality of shipping categories may be grouped in a manner such that data comprising a digital description of a physical property in each category is grouped to form a digital description of a physical item having multiple physical properties. In various embodiments, classification engine 110, containing the digital item profile, communicates with classification database 130, containing a plurality of shipping categories. Rules describing the correspondence between characteristics and categories may be defined on the classification engine 110 or the classification database 130. In various embodiments, a rule may specify that characteristics may match to categories having an exact data term match. For example, classification database 130 may have a first particular category comprising a digital description of the physical property “wooden” which matches the stored characteristic term “wooden” in the digital item profile. The first particular category may then be selected as part of a set of shipping categories of the plurality of shipping categories which are determined to be aligned with the stored characteristics in the digital item profile.

In various further embodiments, rules may specify that characteristics may match to categories having a similar or broader definition than the characteristic. For example, classification database 130 may have a second particular category specifying the term “square prism.” A square prism being a broad category encompassing a cubic shape, the characteristic term “cubic” in the item profile may correspond to the second particular category of a “square prism” and the second particular category may then be selected as part of the plurality of shipping categories determined to be aligned with the stored characteristics in the digital item profile.

At step 240, a classification code is generated based on the determined set of shipping categories. In various embodiments, the categories that are determined to correspond to the stored characteristics in the digital item profile are synthesized to create a sequence of characters or data representing a classification code. The classification code is used in future commercial activities. In various embodiments, the classification database 130 sends an indication including data to the classification engine 110 of which shipping categories were determined as part of step 230. The classification engine 110 may then utilize a set of rules specifying the correspondence between a grouping of categories and classification data to generate a classification code based on the determined shipping categories. The rules specifying correspondence between the grouping of categories and classification data may be any rules sufficient to generate a valid classification code.

In various embodiments, each particular shipping category may correspond to a set of specified character codes. For example, a classification code may require at least six characters to be a valid classification code. The shipping category “wooden” may correspond to a sub-code of “A01” and the shipping category “Square Prism” may correspond to a sub-code of “E01.” The sub-codes may be concatenated to form the full classification code “A01E01” to generate a valid classification code which accurately describes the nature of the crate item which will be involved in commercial shipping.

At step 250, the item involved in commerce is associated with the generated classification code. In various embodiments, the association is the storing of the classification code in the digital item profile representing the item involved in commerce. For example, the digital item profile representing the “crate” may have a new data structure representing the computer string “A01E01” added to the digital item profile. In various embodiments, the association is a digital association made between two or more data entities in a system. For example, a digital representation of the crate item may be mapped to a digital representation of the classification code and the resulting mapping data structure is stored in a database or sent to external systems for commercial processing. In various embodiments, the association is a modification of the physical item involved in commerce to include a physical representation of the commercial code. For example, a shipping label could be printed on a labelling paper and attached physically to the crate to aid commercial shipping entities in the transportation of the crate from one destination to another.

### Example Embodiments

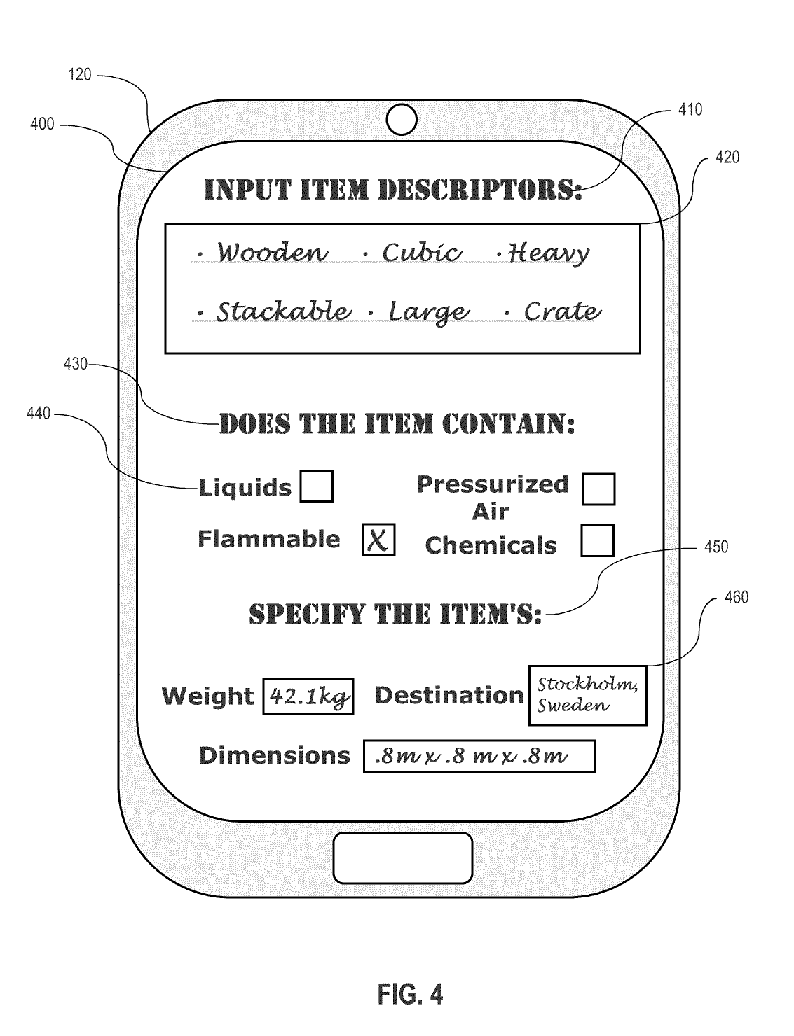

FIG. 4 depicts an example embodiment that may be used in implementing the example process. Specifically, FIG. 4. depicts mobile device 120 being utilized as a user device for the inputting of item characteristics that are sent to classification engine 110. In various embodiments, any user device capable of receiving input from a user and sending the received input can be used to facilitate the transfer of item characteristics. Mobile device 120 comprises interactive screen 400 which simultaneously displays relevant information to a user and accepts user input. In various embodiments, interactive screen 400 displays a digital representation of commerce portal 150 which facilitates the transfer of data between mobile device 120 and classification engine 110.

Interactive screen 400 may depict a descriptive writing prompt 410 for prompting a user to manually type or input characteristics at mobile device 120 which describe an item involved in commerce. A user may use any form of input to respond to descriptive writing prompt 410 such as manual typing, voice recognition, predictive text selection or any other input method sufficient to satisfy descriptive writing prompt 410. User input which is responsive to descriptive writing prompt 410 may be entered in writing block 420. Input to writing block 420 may be in the form of characters, numbers, images, or any other data sufficient to satisfy descriptive writing prompt 420. As depicted in FIG. 4, a user has responded to descriptive writing prompt 410, “INPUT ITEM DESCRIPTORS:” with the singular typed words “Wooden,” “Cubic,” “Heavy,” “Stackable,” “Large,” and “Crate,” in writing block 420 to describe the wooden crate.

Interactive screen 400 may depict a descriptive checklist prompt 430 for prompting a user to manually indicate whether a certain characteristic of an item is present. The descriptive checklist prompt 430 may be fulfilled by indicating at a checklist item 440 whether the certain characteristic of the item is present. Indications at the checklist item 440 may include user input such as touch recognition, voice recognition, predictive recognition, or any other input necessary to signify the existence or lack thereof of the certain characteristic specified by checklist item 440. As depicted in FIG. 4, a user has responded to descriptive checklist prompt 430 “DOES THE ITEM CONTAIN:” by placing an indicating character in the checklist item 440 box next to the word “Flammable” and refraining by inputting an indicator at any other checklist item 440 in order to specify that the wooden crate is a flammable object, but is not a liquid, pressured air, or chemical.

Interactive screen 400 may depict a descriptive field prompt 450 for prompting a user to manually indicate, with specific data, a certain characteristic of an item that is present. The descriptive field prompt 450 may be answered by inputting at a field item 460, the state or measurements of a particular characteristic of the item. Indications at the checklist item 440 may include user input such as typing, voice recognition, predictive recognition, historical field auto-fill data, or any other input necessary to signify the state of a particular characteristic specified by field item 460. As depicted in FIG. 4, a user has responded to descriptive field prompt 450 “SPECIFY THE ITEM'S:” by placing numerical values and measurement units in the field item 460 boxes in order to specify that the “Crate” has a weight of 42.1 kilograms, a shipping destination of Stockholm, Sweden, and dimensions of roughly 80 centimeters measured on all sides of the crate.

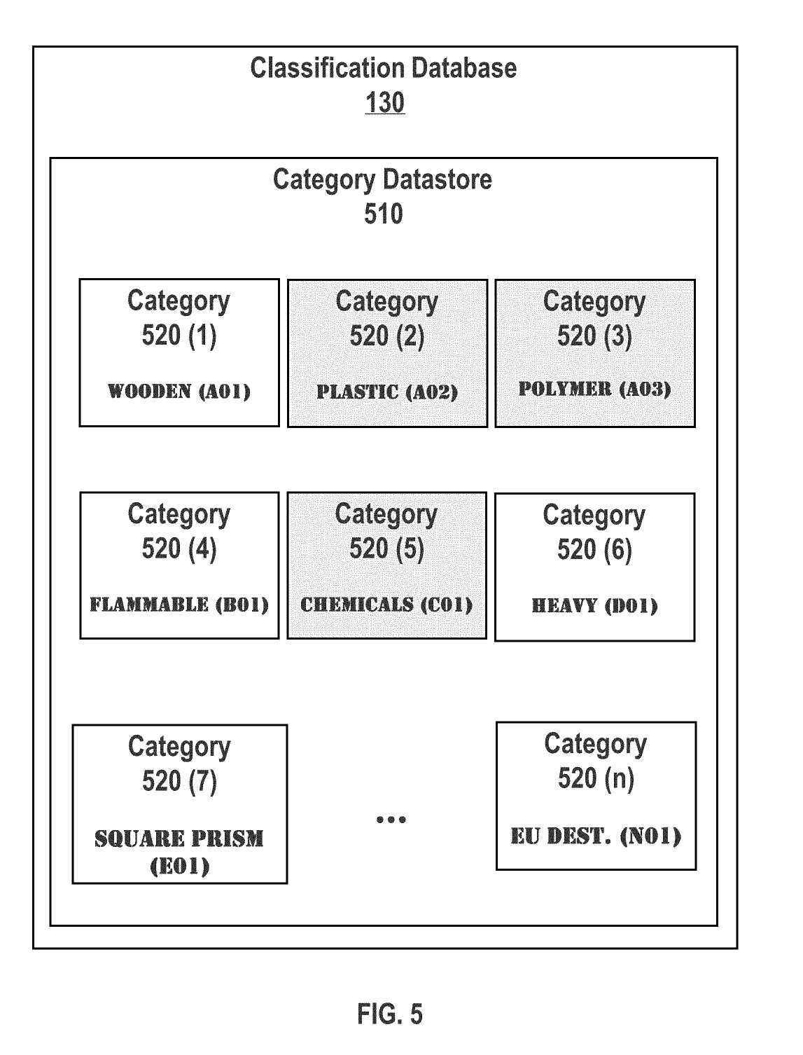

FIG. 5 depicts an example embodiment that may be used in implementing the example process. Specifically, FIG. 5. depicts classification database 130 during the determination 230 of a set of shipping categories based on the characteristics defined on mobile device 120 in FIG. 4 and sent to classification engine 110. Classification database 130 may have stored thereupon, a database such as category datastore 510. Category datastore may comprise one or more categories 520(1)-520(n) which are used in the generation 240 of a classification code.

During the determination 230 of the set of shipping categories corresponding to the digital item profile, classification database 130 may determine a subset of the shipping categories that are included in the determined set of shipping categories or excluded from the determined set of shipping categories. In various embodiments, inclusion or exclusion of certain shipping categories may automatically cause classification database to include or exclude certain additional categories from the determination 230.

As depicted in FIG. 5, the categories 520(1), 520(4), 520(6), 520(7) and 520(n) are left unshaded as indicating the determination that those categories correspond to the item profile generated using data from inputs at interactive screen 400. For example, categories 520(1), 520(4) and 520(6) are all categories having term data corresponding directly to terms in the digital item profile. Category 520(7) has term data “Square Prism” which corresponds to narrower characterization data “Cubic” which it encompasses. Similarly, category 520(n) has term data “EU Destination”, signifying the European Union member countries as destination data, and corresponds to narrower characterization data “Stockholm, Sweden”, which it encompasses. Categories 520(2), 520(3), and 520(5) are shaded as indicating the exclusion of these categories as not corresponding to the item profile.

In various embodiments, rules specifying the generation of a classification code based on the determined categories may comprise any set of data correspondence or parameters sufficient to generate a classification code from the determined categories. In various further embodiments, the determined categories in the category datastore 510 may directly correspond with sub-codes of characters which together form a valid classification code. As depicted in FIG. 5, determined categories each contain a sub-code of characters which can be grouped to form a corresponding valid classification code.

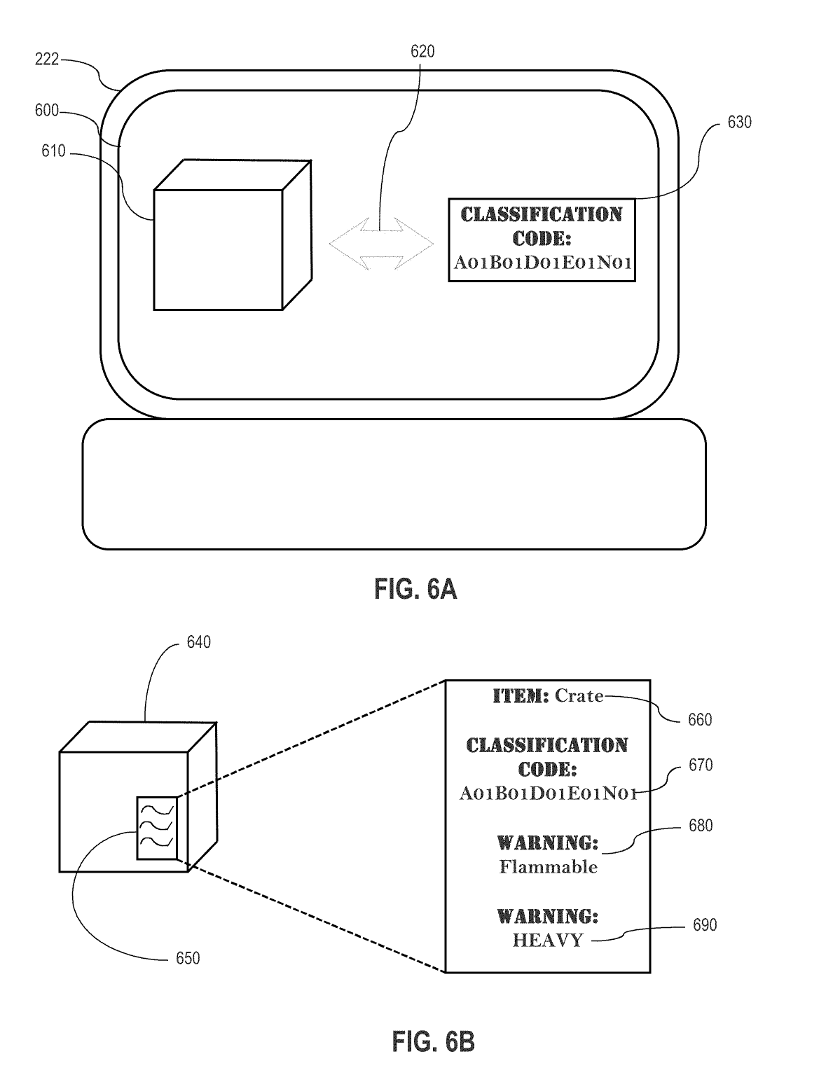

FIG. 6A depicts an example embodiment that may be used in implementing the example process. Specifically, FIG. 6A depicts the association between a digital representation of an item and the corresponding generated classification code for that object. In various embodiments, a user device such as computer device 122 may depict to a user, through commerce portal 150, the association between the item in commerce and the generated classification code. Computer device 122 has therein computing display 600 which depicts a visual representation of commerce portal 150. Through commerce portal 150, a user may view the association 620 between a digital representation 610 of the physical item in commerce and the generated commercial code 630. Digital representation 610 may be the digital item profile or any other digital data embodiment of the physical item in commerce sufficient to convey association between the item and the commercial code 630. In various embodiments, commerce portal 150 may print or otherwise create a physical manifestation of commercial code 630 to display on the physical item.

FIG. 6B depicts an example embodiment that may be used in implementing the example process. Specifically, FIG. 6B depicts an example embodiment in which the physical item in commerce 640 has been associated with the classification code. As depicted in FIG. 6, physical item in commerce 640 may have thereupon a physical shipping label 650 generated by commerce portal 150. Physical shipping label 650 may further comprise physical manifestations of various physical or commercial characteristics associated with the physical item in commerce 640, such as a generated name for the physical item 660, the associated classification code printed in a physical format 670, and one or more characteristics of the physical item presented in physical format, such as warning labels 680 and 690.

### Additional Embodiments

In various embodiments not pictured in FIGS. 4-6, the receiving item characteristics used to generate the digital item profile include any combination of user input, historical data from a shipping database, commercial guidelines describing rules associated with commercial codes, or any other data sufficient to improve the generation of a digital item profile. For example, a historical database may send, to the classification engine 110, historically accepted characteristics for a historical item used in previous commercial shipping activities which closely approximates an item in commerce that is the subject of process 200.

In various embodiments, the received one or more physical characteristics are generated by user input in any manner sufficient to send one or more physical characteristics to the classification engine 110. Examples of user input include, but are not limited to, direct user input, user typing, user field selection, analysis of a photograph, analysis of a user's description, or analysis of historical data provided by a user.

In various embodiments, the classification engine 110 may generate two separate classification codes based on a single digital item profile and may associate both classification codes with the item in commerce. For example, in cases where a particular category of the plurality of categories may or may not correspond to a physical characteristic of the item in commerce depending on interpretation, the classification engine 110 may generate a first classification code corresponding to a set of categories including the particular category, and a second classification code corresponding to a set of categories excluding the particular category. In various further embodiments, a user utilizing a user device 120-122 may review both the first and second classification codes and select the classification code which more closely approximates the item in commerce. In various further embodiments, in response to the selection of the classification code which more closely approximates the item, the other classification code may be disassociated with the item. In various further embodiments, the commerce portal 150 may assist a user in selecting a recommended classification code. In various embodiments, a classification code is not associated with an item in commerce until a user has approved the classification code at a user device 120-122.

In various embodiments, a time tracking system may track the elapsed time since any step of process 200 has begun, to promote efficient facilitation of the process. In various further embodiments, the time tracking system receives a limiting time value which comprises the maximum amount of time that process 200 or any step of process 200 may take to completion. In various further embodiments, the time tracking system may stop any step of process 200 when the limiting time value is surpassed by the elapsed time since a step of process 200 has begun. In various further embodiments, the time tracking system is in communication with classification engine 110 and sends an indication to classification engine 110 to generate a classification code based on categories which have been determined during in the elapsed time. For example, when the determination of categories corresponding to the physical characteristics of an item proceeds for a time longer than a user believes is efficient, a user may direct the time tracking system to halt the determination and automatically generate an approximate classification code based on a set of categories which had been determined up to that point. In various embodiments, system 100 may collect time statistics involved in the facilitation of process 200 and analyze the time statistics to modify certain steps of the process 200 or the activities performed by system 100 to promote efficient time management techniques.

In various embodiments, a resource tracking system tracks utilized computer resources such as computer processor capacity, computer memory storage, computer bandwidth utilization, or any other metric corresponding to the use of computer resources. In various further embodiments, the resource tracking system receives threshold values for computer resource utilization. In response to determining that any step of process 200 has utilized computer resources above the threshold value(s), the process 200 may be stopped or redirected to a different step in process 200 as described above.

In various embodiments, system 100 cannot determine any categories of the plurality of categories which correspond to the received physical characteristics of an item. In various further embodiments, in response to determining that there are no categories in the classification database 130 that correspond to the received physical characteristics, an additional set of categories may be sent to the classification database 130 and included in the plurality of categories. In various further embodiments, determination step 230 is re-done including the newly updated plurality of categories. In various embodiments, the updating of the plurality of categories with additional categories is done multiple times until at least one category is determined to correspond to the received physical characteristics of an item.

In various embodiments, system 100 cannot determine any categories of the plurality of categories which correspond to the received physical characteristics of an item. In various further embodiments, in response to determining that there are no categories in the classification database 130 which correspond to the received physical characteristics, a prompt is sent to a user device 120-122 prompting a user to input additional physical characteristics of an item. In various embodiments, the digital item profile is updated based on the additional physical characteristics received from the user device 120-122. In various further embodiments, the updating of the digital item profile with prompted physical characteristics is done multiple times until at least one category is determined 230 to correspond to the received physical characteristics of an item in the updated digital item profile

In various embodiments, in response to the determination that a first category of the plurality of categories corresponds to the received physical characteristics of an item, a second category of the plurality of categories may be automatically determined to correspond to the received physical characteristics of an item as well. For example, a digital item profile having a “cubic” physical property may be determined to correspond to a category specifying a “square prism.” The determination that the “square prism” category corresponds to the physical property may automatically cause the determination that a category specifying a “stackable” property corresponds to the received physical characteristics as well.

In various embodiments, in response to the determination that a first category of the plurality of categories corresponds to the received physical characteristics of an item, a second category of the plurality of categories may be automatically determined not to correspond to the received physical characteristics of an item. For example, a digital item profile having a “wooden” physical property may be determined to correspond to a category specifying a “solid” state of matter. The determination that the “solid” category corresponds to the physical property may automatically cause the determination that a category specifying a “liquid” property does not correspond to the received physical characteristics.

In various embodiments, in response to the determination that a first category of the plurality of categories does not correspond to the received physical characteristics of an item, a second category of the plurality of categories may be automatically determined to correspond or not to correspond to the received physical characteristics of an item in a similar manner to that described above. In various embodiments, a user may manually select or exclude certain categories from the determination.

In various embodiments, the classification code may be any code or sequence of data which is identifiable in some aspect of commercial shipping. In various further embodiments, the classification code is presented in a format conforming to format rules as defined by a system, such as the Harmonized System (HS) of shipping codes used by the World Customs Organization or the United State Harmonic Tariff Schedule (HTS). In various embodiments, rules or customs associated with a system of shipping codes are stored in system 100 and updated periodically. The various further embodiments, system 100 performs a consistency check on all generated classification codes to ensure compliance with a system of shipping codes.

In various embodiments, the received physical characteristics of an item may include any combination of physical properties, use, purpose, shipping origin, shipping destination, shipping context, or any other information sufficient to describe a property of an item. Examples of received physical characteristics include, but are not limited to: state of matter, composition of matter, weight, mass, volume, gender, vital status, height, place of origin, place of destination, genealogy, genetic markers, etc. Examples of items which may be subject to commerce include, but are not limited to: storage containers, food products, animal or plant matter, chemicals, electronic devices, species, raw materials, plastics or polymers, hazardous materials, textiles, machines, furniture, works of art, or any other item or material which may be subject to proper commercial shipping activities.

In various embodiments, digital data comprising the associated classification code and item in commerce is forwarded to one or more external systems or entities to further a commercial transaction. For example, associating an item in commerce with a commercial code may comprise updating the digital item profile to contain an instance of the commercial code. The digital item profile may then be forwarded for processing by one or more external systems, such as a shipping facility system, a freight management system, a customs and/or port-of-entry system, a buyer, a seller, or any other entity involved in a commercial transaction incidental to the item in commerce.

In various embodiment, digital data comprising the associated classification code and item in commerce is forwarded to a physical association system which responsively performs one or more functions which will create or update a physical characteristic of the item in commerce. For example, a printing system is a physical association system may receive the updated digital item profile and responsively print a shipping label comprising the commercial code and any other relevant commercial data, such as item dimensions, warning labels, handling instructions or a commercial itinerary. The printing label is attached to the item in commerce and shipped based on the contents of the shipping label.

In various embodiments, digital data comprising the associated classification code and item in commerce is forwarded to a database system to improve the generation of classification codes. For example, the digital item profile may be sent to one or more database systems, such as classification database 130. Classification database 130 may store in memory the digital item profile or create new categories in the category datastore 510 corresponding to one or more physical characteristics in the digital item profile. In various further embodiments, classification database 130 may recognize a subsequent digital item profile substantially similar to the stored digital item profile and responsively associate the classification code in the stored digital item profile with the item in commerce corresponding to the subsequent digital item profile. Alternatively, the classification database 130 may determine one or more new categories generated from the stored digital item profile to be included in the plurality of shipping categories to further aid in the generation of the subsequent classification code.

Implementation Mechanisms

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

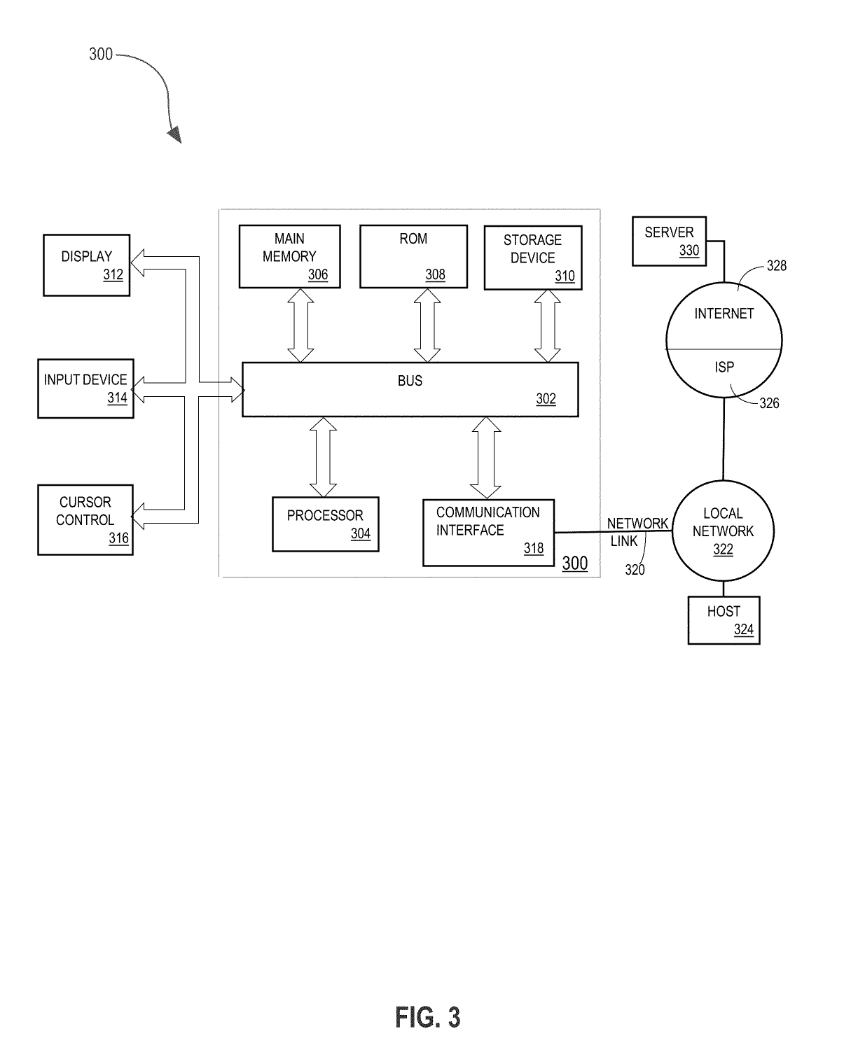

FIG. 3 is a block diagram that depicts an example computer system with which an embodiment may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanism(s) for communicating information and/or instructions between the components of the computer system 300 over electronic signal paths. The I/O subsystem 302 may include an I/O controller, a memory controller and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or other dynamic storage device. Memory 306 also may be used for storing temporary variables or other intermediate information during execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read only memory (ROM) 308 or other static storage device coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disk such as CD-ROM or DVD-ROM and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include other type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators or servos.

At least one input device 314 is coupled to I/O subsystem 302 for communicating signals, data, command selections or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis, for example, x, and a second axis, for example, y, that allows the device to specify positions in a plane. Another type of input device is a wired, wireless, or optical control device such as a joystick, wand, console, steering wheel, pedal, gearshift mechanism or other type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic detectors, other sensors or detectors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 such as place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to network link(s) 320 that are directly or indirectly connected to at least one communication networks, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 322 broadly represents a local area network (LAN), wide-area network (WAN), campus network, internetwork or any combination thereof. Communication interface 318 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through a network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a world-wide packet data communication network represented as internet 328. A server computer 330 may be coupled to internet 328. Server 330 broadly represents any computer, data center, virtual machine or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer and data storage layer such as a relational database system using structured query language (SQL) or no SQL, an object store, a graph database, a flat file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A computer-implemented method comprising:
receiving, at a computer system, a first set of item characteristics associated with an item in commerce;
wherein the item in commerce is a physical object having one or more physical characteristics and is involved in commercial shipping;
generating, by the computer system, an item profile corresponding to the item in commerce;
wherein the item profile comprises the one or more physical characteristics;
determining, by the computer system, from a plurality of shipping categories, a first set of shipping categories corresponding to the one or more physical characteristics in the item profile;
based on the first set of shipping categories, generating, by the computer system, a first classification code;
associating, by the computer system, the item in commerce with the first classification code.

2. The computer-implemented method of claim 1, further comprising:
requesting, from a user device, custom input characteristics;
receiving, from the user device, custom input characteristics;
wherein the first set of item characteristics associated with the item in commerce comprise the custom input characteristics.

3. The computer-implemented method of claim 2, further comprising:
receiving, at the computer system, a second set of item characteristics associated with the item in commerce;
wherein the second set of item characteristics is historical item in commerce data associated with the item in commerce;
updating, by the computer system, the item profile to include the second set of item characteristics.

4. The computer-implemented method of claim 1, further comprising:
generating, by the computer system, a second classification code that is different than the first classification code;
wherein the second classification code is generated based at least upon the first set of shipping categories;
associating, by the computer system, the item in commerce with the second classification code.

5. The computer-implemented method of claim 4, further comprising:
prompting, at a user device, selection of one of either the first or second classification codes;
receiving, from the user device, selection of the second classification code;
in response to receiving, from the user device, selection of the second classification code, disassociating, by the computer system, the item in commerce with the first classification code.

6. The computer-implemented method of claim 1, further comprising:
receiving, by the computer system, a time limit value for determining the first set of shipping categories;
tracking, by the computer system, an elapsed time value;
wherein the elapsed time value is a length of time that has passed since determining the first set of shipping categories has begun;
stopping, by the computer system, the determination the first set of shipping categories in in response to determining that the elapsed time value exceeds the time limit value.

7. The computer-implemented method of claim 1, further comprising:
in response to determining that no shipping categories of the plurality of shipping categories correspond to the one or more physical characteristics in the item profile, receiving, at the computer system, one or more additional shipping categories;
updating the plurality of shipping categories to include the one or more additional shipping categories;
determining, by the computer system, from the updated plurality of shipping categories, a first set of shipping categories that correspond with the item profile.

8. The computer-implemented method of claim 1, further comprising:
in response to determining that no shipping categories of the plurality of shipping categories correspond to the one or more physical characteristics in the item profile, prompting, at a user device, additional input comprising one or more additional physical characteristics associated with the item in commerce;
updating, by the computer system, the item profile to include the one or more additional physical characteristics;
determining, by the computer system, a first set of shipping categories that correspond with the updated item profile.

9. The computer-implemented method of claim 1, further comprising:
receiving, by the computer system, an indicator specifying one or more excluded shipping categories of the plurality of shipping categories.
wherein determining the first set of shipping categories correspond to one or more physical characteristics in the item profile comprises excluding the one or more excluded shipping categories from the determination.

10. The computer-implemented method of claim 1, further comprising:
receiving, by the computer system, an indicator specifying one or more included shipping categories of the plurality of shipping categories.
wherein determining the first set of shipping categories correspond to one or more physical characteristics in the item profile comprises including, at least, the one or more included shipping categories in the determination.

11. One or more non-transient computer readable storage media comprising instructions which, when executed by a processor, cause the processor to:
receive, at a computer system, a first set of item characteristics associated with an item in commerce;
wherein the item in commerce is a physical object having one or more physical characteristics and is involved in commercial shipping;
generate, by the computer system, an item profile corresponding to the item in commerce;
wherein the item profile comprises the one or more physical characteristics;
determine, by the computer system, from a plurality of shipping categories, a first set of shipping categories corresponding to the one or more physical characteristics in the item profile;
based on the first set of shipping categories, generate, by the computer system, a first classification code;
associate, by the computer system, the item in commerce with the first classification code.

12. The non-transient computer readable storage media of claim 11 further comprising instructions which, when executed by the processor cause the processor to:
request, from a user device, custom input characteristics;
receive, from the user device, custom input characteristics;
wherein the first set of item characteristics associated with the item in commerce comprise the custom input characteristics.

13. The non-transient computer readable storage media of claim 12 further comprising instructions which, when executed by the processor cause the processor to:
receive, at the computer system, a second set of item characteristics associated with the item in commerce;
wherein the second set of item characteristics is historical item in commerce data associated with the item in commerce;
update, by the computer system, the item profile to include the second set of item characteristics.

14. The non-transient computer readable storage media of claim 11 further comprising instructions which, when executed by the processor cause the processor to:
generate, by the computer system, a second classification code that is different than the first classification code;
wherein the second classification code is generated based at least upon the first set of shipping categories;
associate, by the computer system, the item in commerce with the second classification code.

15. The non-transient computer readable storage media of claim 14 further comprising instructions which, when executed by the processor cause the processor to:
prompt, at a user device, selection of one of either the first or second classification codes;
receive, from the user device, selection of the second classification code;
in response to receiving, from the user device, selection of the second classification code, disassociate, by the computer system, the item in commerce with the first classification code.

16. The non-transient computer readable storage media of claim 11 further comprising instructions which, when executed by the processor cause the processor to:
receive, by the computer system, a time limit value for determining the first set of shipping categories;
track, by the computer system, an elapsed time value;
wherein the elapsed time value is a length of time that has passed since determining the first set of shipping categories has begun;
stop, by the computer system, the determination the first set of shipping categories in in response to determining that the elapsed time value exceeds the time limit value.

17. The non-transient computer readable storage media of claim 11 further comprising instructions which, when executed by the processor cause the processor to:
in response to determining that no shipping categories of the plurality of shipping categories correspond to the one or more physical characteristics in the item profile, receive, at the computer system, one or more additional shipping categories;
update the plurality of shipping categories to include the one or more additional shipping categories;
determine, by the computer system, from the updated plurality of shipping categories, a first set of shipping categories that correspond with the item profile.

18. The non-transient computer readable storage media of claim 11 further comprising instructions which, when executed by the processor cause the processor to:
in response to determining that no shipping categories of the plurality of shipping categories correspond to the one or more physical characteristics in the item profile, prompt, at a user device, additional input comprising one or more additional physical characteristics associated with the item in commerce;
update, by the computer system, the item profile to include the one or more additional physical characteristics;
determine, by the computer system, a first set of shipping categories that correspond with the updated item profile.

19. The non-transient computer readable storage media of claim 11 further comprising instructions which, when executed by the processor cause the processor to:
receive, by the computer system, an indicator specifying one or more excluded shipping categories of the plurality of shipping categories.
wherein determining the first set of shipping categories correspond to one or more physical characteristics in the item profile comprises excluding the one or more excluded shipping categories from the determination.

20. The non-transient computer readable storage media of claim 11 further comprising instructions which, when executed by the processor cause the processor to:
receive, by the computer system, an indicator specifying one or more included shipping categories of the plurality of shipping categories.
wherein determining the first set of shipping categories correspond to one or more physical characteristics in the item profile comprises including, at least, the one or more included shipping categories in the determination.
